(19) United States
(12) Patent Application Publication
(10) Pub. No.: US 2011/0208575 A1
(43) Pub. Date: Aug. 25, 2011

(54) SYSTEM AND METHOD FOR GENERATING INTERACTIVE ADVERTISEMENTS

(75) Inventors: Mayank Bansal, Sunnyvale, CA (US); Arun Sundaresan, San Jose, CA (US); Brian Bouta, Santa Clara, CA (US)

(73) Assignee: Yahoo! Inc., Sunnyvale, CA (US)

(21) Appl. No.: 12/710,966

(22) Filed: Feb. 23, 2010

(51) Int. Cl. G06Q 30/00; G01C 21/00; G06F 3/048; G06F 15/16; G06F 17/30

(52) U.S. Cl. 705/14.25; 705/14.39; 701/300; 715/840; 709/248; 707/769; 235/375; 707/E17.014

(57) ABSTRACT

A system and method for generating a plurality of interactive advertisements are provided. The system includes an advertisement generator operable to generate online advertisements displaying coupon offers. An ad server is provided for rendering the advertisements to users. Each advertisement includes an interactive button operable to display a printable copy of the advertised coupon to the user. The coupon includes a unique identifier visibly embedded therein, wherein the unique identifier enables the user to redeem the coupon.

### SUMMARY

The present application provides a system and method for generating interactive advertisements. The system comprises a database for storing coupon files. The coupon files include data for generating a redeemable coupon having a unique identifier. An advertisement generator in communication with the database is operable to generate advertisements based on the coupon files. The system further comprises an ad server in communication with the advertisement generator. The ad server is configured to display online advertisements to users. The online advertisements include an ad body that may display text detailing a coupon offer. The advertisements further include a set of interactive components that are separate from the ad body.

According to one aspect, users may be redirected to a predetermined web page in response to clicking an area of the ad body. The web page may provide additional details regarding a product or service described in the online advertisement. According to another aspect, a printable copy of the redeemable coupon is displayed in response to a user selecting an interactive component. Furthermore, selecting an alternative interactive component enables a user to save the coupon in a storage medium such as an online account.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1A is a graphical representation of a website for enabling users to search and save online coupons;

FIG. 1B is a graphical representation of an online account associated with the website shown in FIG. 1A;

FIG. 2 is a schematic view of a system for generating interactive advertisements;

FIG. 3A is a graphical representation of an interactive advertisement according to one embodiment of the present disclosure;

FIG. 3B is a graphical representation of a printable coupon associated with the interactive advertisement shown in FIG. 3A;

FIG. 3C is a graphical representation of an interactive advertisement according to an alternative embodiment of the present disclosure;

FIGS. 4A-4C include graphical representations of a mobile phone for accessing coupons stored in an online account associated with a user;

FIG. 5 is a flowchart illustrating a method for generating interactive advertisements; and

FIG. 6 is a schematic view of a computer system for implementing the methods described.

It should be understood that throughout the drawings, corresponding reference numerals indicate like or corresponding parts and features.

### DETAILED DESCRIPTION

Coupons are commonly distributed for promoting products and services. Despite the obvious benefits of coupons, a vast majority of purchasers fail to utilize coupons due to the tedious process of manually sifting through advertisements, clipping desirable coupons, and saving them. Moreover, many customers that do undergo this process often fail to utilize saved coupons at the time of purchase. For instance, customers commonly forget to bring coupons with them and some even forget about the coupons entirely. Furthermore, since coupons do not provide any means for reminding customers to use them, customers frequently fail to use coupons prior to expiring.

Nonetheless, the advent of the Internet eases many of the problems associated with conventional coupons, as the practice of serving coupons through Internet-based advertising has become increasingly popular among advertisers. Online advertisements may comprise banner ads, links to web pages, images, audio and/or video, animations, two- and three-dimensional objects, etc.

Client devices, communicatively coupled to a network such as the Internet, are capable of accessing various websites that may display advertisements. For example, a user of a client device may submit a search request comprising one or more terms to a search engine, which causes the search engine to retrieve a web page comprising links to content, as well as advertisements that may be related to the search terms provided by the user. The search engine generates and displays a result set to a user who may then select or view items in the result set, including one or more advertisements. Revenue for the search engine provider is typically generated from the advertisements that are displayed to users in response to search requests.

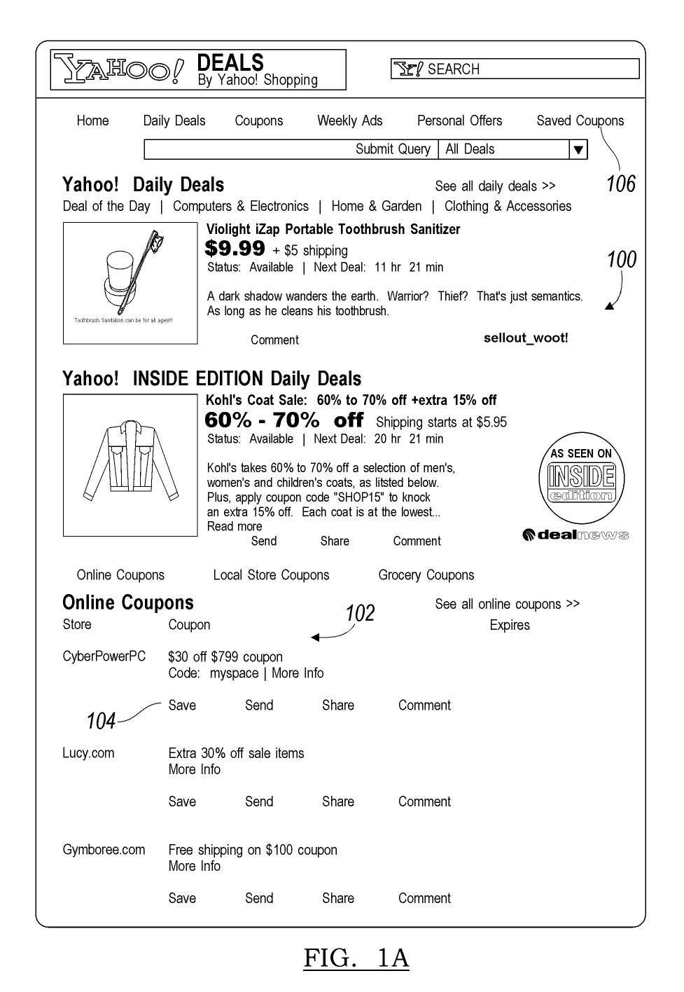

Despite the increasing popularity of online advertising and the relative simplicity in which users may take advantage of advertisement offers, advertisers continue to seek improvements to enhance the overall effectiveness of online advertising. For instance, it is not rare for an Internet user to completely ignore an advertisement, especially one considered irrelevant or of little use to the user. The service provider Yahoo!®, however, has a website known as “Yahoo! Deals” (www.deals.yahoo.com) that provides one solution to the foregoing problem. An exemplary homepage of the Yahoo! Deals website is shown in FIG. 1A and designated generally at 100.

Yahoo! Deals 100 allows Internet users to search for online coupons. For instance, users may search for coupons by location, category, store, etc. If an Internet user has a Yahoo! account, the user may save coupons presented within the Yahoo! Deals website 100 in the user's account. For instance, if a user wants to save the “$30 off $799 coupon” 102 offered by CyberPower Inc. in FIG. 1A, the user may select (e.g., click) the “Save” tab 104. The coupon will then be saved in an online account managed by Yahoo! Deals 100. To view the coupon, the user may simply click the “Saved Coupons” tab 106, which redirects the user to a web page associated with the user's online account 108, as shown in FIG. 1B. The online account 108 lists all coupons saved by the user.

In one implementation, Yahoo! users can only save coupons to their account 108 by navigating through the Yahoo! Deals website 100 itself. Thus, if a Yahoo! user comes across an online coupon displayed on a web page that is not served by the Yahoo! Deals website 100 (or if the web page is not otherwise associated with Yahoo!), the user is unable to save the coupon to their Yahoo! Deals account 108. Moreover, the coupons displayed in Yahoo! Deals 100 are generally linked to a web page where users can take advantage of the coupon offer. That is, coupons cannot be printed directly from the Yahoo! Deals website, if at all (e.g., most coupon offers are only redeemable online). As such, a user cannot use a coupon from the Yahoo! Deals website 100 at an actual retail store so that the user may view the product physically prior to purchasing it.

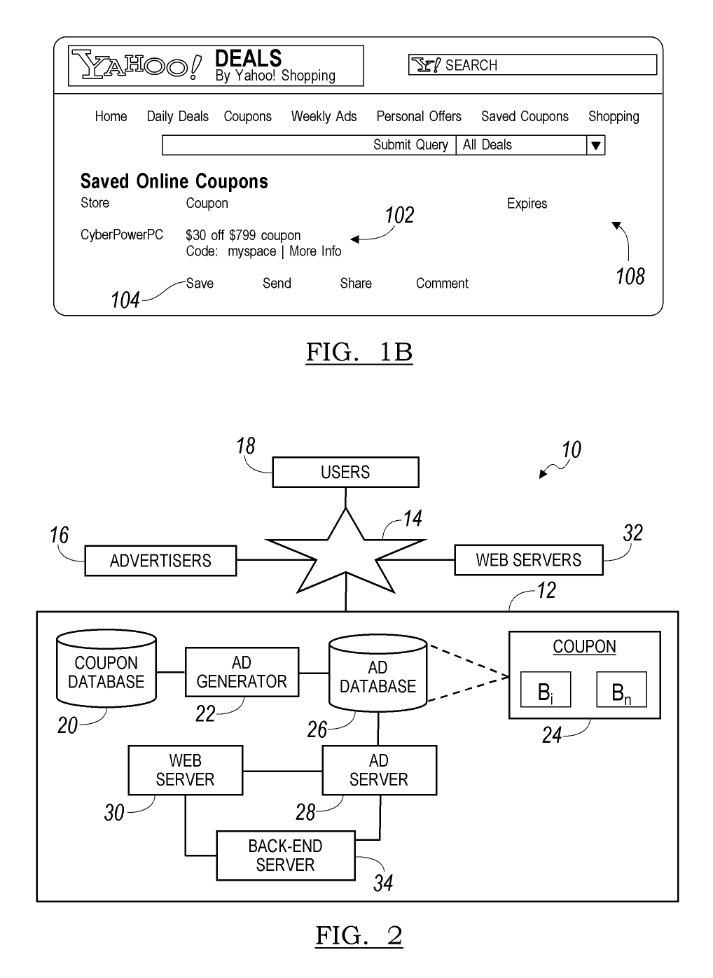

Referring now to FIG. 2, a system embodying the principles of the present application is illustrated therein and designated at 10. The system 10 is configured as a client-server architecture. A “client” is typically a member of a class or group that uses the services of another unrelated class or group. In the context of a computer network, such as the Internet, a client is a process (e.g., roughly a program or task) that requests a service provided by another process, known as a server program. The client process may generally use the requested service without having to know any working details about the other server program or the server itself.

In networked systems, a client process usually runs on a client device, e.g., a computer (or component thereof) that accesses shared network resources provided by another computer running a corresponding server process. Such client devices may include laptops, home computers, personal digital assistant (PDA) devices, mobile phones, set top boxes, game consoles, portable electronic devices, etc. As will be understood to those of ordinary skill in the art, it is possible for a client process and a server process to run on the same device.

A “server” is typically a remote computer system that is accessible over a communications medium such as the Internet. The client process may be active in a second computer system, and communicate with the server process over a communications medium that allows multiple clients to take advantage of the information-gathering capabilities of the server. Thus, the server essentially acts as an information provider for a computer network.

The system 10 comprises a server 12 capable of being in communication with a distributed network 14, which may include a connection to one or more networks such as the Internet. Other forms of a network for communication include, but are not limited to, a local and/or wide area network, a wireless network such as a WiFi™ or WiMAX™ network, a mobile data network, or any other suitable network for communication. While only one server 12 is depicted in the drawings, those of ordinary skill in the art will appreciate that the system 10 may incorporate a plurality of servers.

The server 12 is operable to execute requests submitted by various entities via the network 14. While certain specific entities are discussed herein, it is to be understood that additional entities capable of accessing the network 14 may be similarly be connected to the server 12. Advertisers 16 create coupons, e.g., on behalf of their own or their clients, to be served to users 18 via the network 14. Advertisers 16 may submit coupons to the server 12 via one or more client devices communicatively linked to the network 14.

According to one aspect, advertisers 16 may submit coupons as an electronic file specifying the content of the coupon. The electronic file may contain text specifying the details of the coupon, graphics, and any other content specified by the electronic file. For instance, the electronic file may also include information such as, but not limited to, an identifier (e.g., a coupon serial number) or a barcode for tracking the coupon, an expiration date, a hyperlink to the coupon provider's website, contact information, etc.

The server 12 includes a storage unit, such as a coupon database 20, for storing coupons submitted by the advertisers 16. The coupon database 20 may be implemented as any type of data storage structure capable of providing for the retrieval and storage of a variety of data types. For instance, the coupon database 20 may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

The server further includes an ad generator 22 communicatively linked to the coupon database 20. The ad generator 22 may be a hardware and/or software module configured to generate a plurality of advertisements. While the ad generator 22 is shown in FIG. 2 as a direct component of the server 12, those of skill in the art will appreciate that the ad generator 22 may be indirectly incorporated with the server 12, remotely connected to the server 12 via a network, and/or may be controlled by a separate entity (e.g., an advertising agency).

The ad generator 22 is configured to incorporate the coupons stored in the coupon database into advertisements 24 to be displayed to users 18 as part of a webpage. More specifically, the ad generator 22 utilizes the content contained in an electronic coupon file and incorporates the content into an ad code, which may be saved as an executable file. When the ad code is executed, an electronic coupon is displayed to a user 18 in the form of an online advertisement 24. The ad code may include instructions written in any suitable human-readable computer programming language.

The ad generator 22 is further configured to include code to create a set of interactive components such as buttons (Bᵢ, . . . Bₙ) within the advertisement 24. The ad generator 22 may therefore incorporate multimedia object technologies (e.g., Java™, Shockwave™, Flash™, etc.) for providing interactive buttons with various functionalities. As will be described in greater detail below, each advertisement 24 is embedded with at least a “save” button and/or a “print” button.

Of course, it should be understood to those of ordinary skill in the art that there might be instances where the ad generator 22 may not need to be employed. For example, advertisers 16 may supply the server 12 with electronic coupon files that already include the ad code necessary to achieve the desired function/result. In that case, the server 12 simply stores the electronic coupon files in a storage unit such as the coupon database 20.

Upon creating an advertisement 24 for a coupon stored in the coupon database 20, the ad generator 22 stores the advertisement 24 in a storage unit such as an advertisement database 26. Analogous to the coupon database 20, the advertisement database 26 may be implemented as any type of data storage structure capable of providing for the retrieval and storage of a variety of data types. For instance, the advertisement database 26 may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

The server 12 is communicatively linked to at least one ad server 28 operable to support multiple advertising formats, such as, but not limited to, BMP, TIFF, GIF, JPEG, and Flash formats. The ad server 28 may be a hardware and/or software module configured to search the advertisement database 26 and retrieve one or more advertisements 24 for display to a user 18. In addition, the ad server 28 may be directly or indirectly incorporated with the server 12, remotely connected to the server 12 via the network 14, and/or controlled by a separate entity (e.g., an advertising agency).

The ad server 28 is communicatively linked to one or more web servers that are operable to retrieve a web page in response to a search request conducted by a user 18 via a client device. For instance, the ad server 28 may be connected to a web server 30 provided by the server 12, or a web server 32 operated by a different entity. In either implementation, the ad server 28 can be configured to embed an appropriate advertisement 24 in a web page retrieved by a web server (e.g., 30 or 32).

The ad server 28 may select advertisements 24 based on a variety of factors such as, but not limited to, time, demographics, category, content, etc. In addition, the ad server 28 may select an advertisement 24 based on a corresponding expected revenue (e.g., expected revenue for a given advertisement 24 may be calculated according to a historical click-through rate associated with the advertisement 24). It is to be understood, however, that the ad server 28 may select advertisements 24 using various algorithms and techniques known to those of ordinary skill in the art.

According to one embodiment, the ad server 28 may select an advertisement 24 based on a user's profile and/or behavior. For instance, a web page displaying a given advertisement 24 may include a tracking object configured to monitor user activity. Alternatively, the ad generator 22 may be configured to embed a tracking object in the advertisement 24 itself. A tracking object may include a component such as an applet program written in an interpretive language such as Java™. Similarly, a tracking object may include a program written in scripting language such as JavaScript™ to track and gather user activity. As will be understood to those of skill in the art, a Java applet and a JavaScript code embedded in a web page or advertisement 24 may be used collectively to gather user data.

The tracking object is operable to obtain information such as metadata regarding a user's behavior and/or profile by tracking user interaction with a client device and/or by collecting information stored within a client device. Such user-related information may include a user's Internet Protocol (IP) address, geographic location, nature or theme of the website on which an advertisement 24 is being displayed, the nature of the specific content viewed by the user 18, the user's web viewing history or patterns, as well as other psychographic data about the user 18 (which may be received from a number of different sources). Information may also be collected about the user's age, location, gender, income, education, ethnicity, product preferences, and a variety of other demographic characteristics that are useful in matching an advertisement to a user 18.

The server 12 may include a back-end server 34 operable to receive user-related data from the tracking object and transmit the data to the ad server 28. In another aspect, the back-end server 34 may communicate user-related data to the web server 30, which in turn, communicates the data to the ad server 38. In either implementation, however, the ad server 28 may select an advertisement 24 based on data obtained from the back-end server 34.

While the back-end server 34 is shown in FIG. 2 as being incorporated with the server 12, it is to be understood that the back-end server 34 may be provided as a separate component remotely connected to the server 12. Furthermore, it is to be understood that the present disclosure is not limited to the use of a tracking object as described above, as any suitable technique for gathering user information may be similarly implemented.

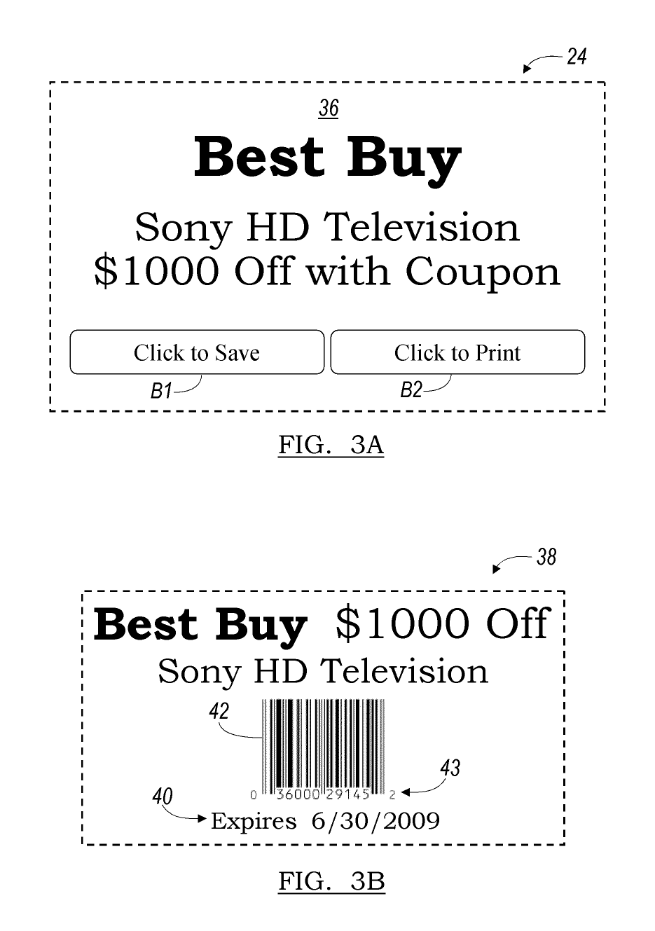

Referring now to FIGS. 3A-3C, an exemplary advertisement 24 created by the system 10 will now be discussed. In FIG. 3A, an advertisement 24 retrieved by the ad server 28 for display to a user 18 is shown. The advertisement 24 may be displayed to a user 18 according to a variety of formats, such as in conjunction with a ranked result set in response to a query, embedded in a web page, a pop-up, etc. The advertisement 24 includes an ad body 36 including text specifying the details of the coupon offer, as well as a first button B1 and a second button B2, which define areas that are different from the ad body 36.

In instances where the electronic coupon file associated with the given advertisement 24 includes a web link (e.g., Uniform Resource Locator), the ad generator 22 is configured to embed the link within the ad body 36. As such, if a user 18 clicks or otherwise selects an area within the ad body 36, the user 18 may be redirected to the web page corresponding the link. In the advertisement 24 depicted in FIG. 3A, for example, clicking on the ad body 36 may redirect the user 18 to the Best Buy® homepage, or to a web page that includes additional details regarding the given coupon.

As shown in FIG. 3A, the first button B1 and the second button B2 include a “save” button B1 and a “print” button B2, respectively. As will be described in greater detail below, clicking the “save” button B1 enables users 18 to save an electronic version of the displayed coupon. Clicking the “print” button B2, on the other hand, enables users 18 to print a copy of the coupon. Moreover, while only a “save” button B1 and a “print” button B2 are shown in FIG. 3A, those of ordinary skill in the art will appreciate that additional buttons may be included.

As shown in FIG. 3C, for example, the advertisement 24 may further include a “Send” button B3, a “Share” button B4, and/or a “Comment” button B5. The “Send” button B3 allows users 18 to send the coupon to others (e.g., via e-mail). The “Share” button B4 allows users 18 to share the coupon with others online (e.g., via Facebook, Twitter, Myspace, etc.). The “Comment” button B5 allows users 18 to post comments regarding the coupon, which may be viewed by online users.

As previously mentioned, the advertisement 24 is prepared using a multimedia platform (e.g., Adobe Flash™). Therefore, the user's client device should include the necessary plug-in(s) and/or software to display the advertisement 24, as well as enable the functionality of each button (e.g., B1-B5). If the client device lacks one or more necessary features, the server 10 may prompt the client device to download and install the necessary browser plug-in, Java™ applet, Java™ script application, Shockwave™ component, or similar program code.

According to a preferred embodiment, when a user 18 clicks the “save” button B1, the coupon 38 is saved in an online user account such as that provided by Yahoo! Deals in FIG. 1B. The system 10 may be configured such that a user 18 may save online coupons rendered on any web page so long as the user 18 is logged into his or her Yahoo! account. Of course, those of skill in the art will appreciate that alternative or additional conditions may be imposed. For instance, the system 10 may be configured such that users 18 may only save coupons displayed on a web page rendered by Yahoo! or its affiliates. Nonetheless, rather than requiring users 18 to expend time and energy in searching for coupons using a website such as Yahoo! Deals 100, the present disclosure provides a means for dynamically serving coupons to users 18 (e.g., based on user profile and/or behavior) by way of online advertisements.

While coupons are preferably saved in an online account 108, it is to be understood that the present disclosure is not so limited, as coupons may be saved according to any suitable technique known the art. For instance, when a user 18 clicks the “save” button B1, a pop-up window may appear that enables the user 18 to electronically save the coupon in a storage area (e.g., local memory, disk, flash drive, etc.) specified by the user 18. Alternatively, the coupon may be automatically saved in a predetermined cleaning medium when a user 18 clicks on the “save” button B1.

According to one embodiment, clicking the “print” button generates a pop-up or otherwise displays a virtual coupon 38 (i.e., a copy of the coupon as it would appear printed), as shown in FIG. 3B. The user 18 may therefore view the coupon 38 and then print it using a designated printing device. The coupon 38 includes an expiration date 40, as well as a machine-readable barcode 42 or other mechanism (e.g., a unique identifier such as a serial or barcode number 43 that may be entered by a cashier) for allowing the user 18 to apply the coupon 38 to the applicable product or service. Hence, users 18 capable of accessing the network 14 using a client device such as a mobile phone may utilize the coupon 38 without printing a physical copy.

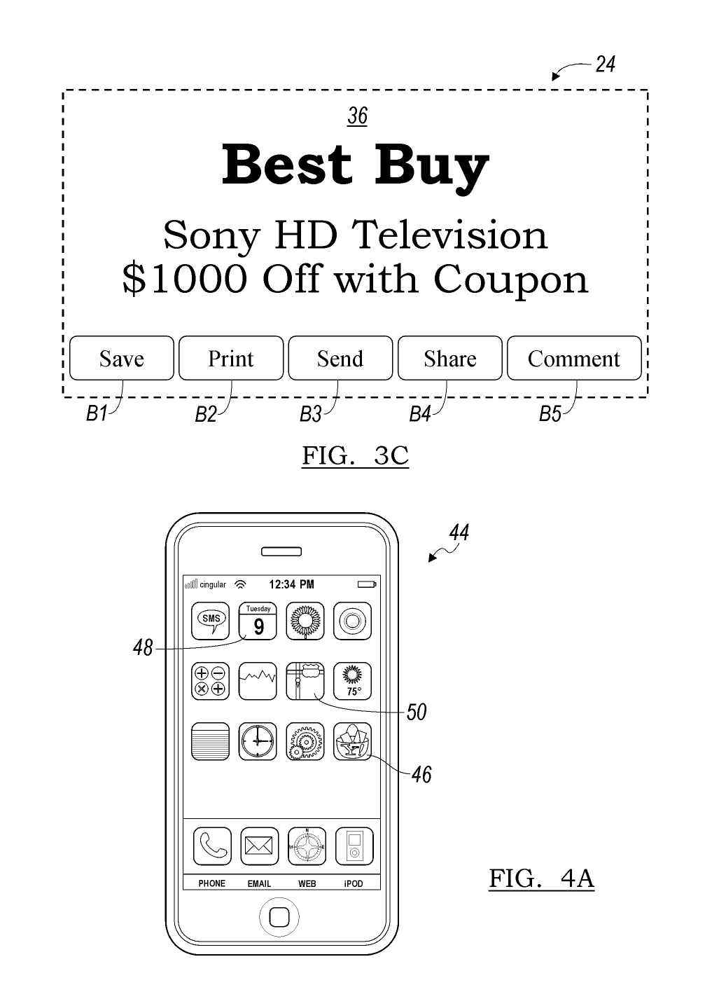

By way of example, a user 18 may use a mobile phone to access web pages displaying advertisements 24 served by the ad server 28. Moreover, a user 18 may use a mobile phone to access the Yahoo! Deals website 100 directly. This enables users 18 to portably search for and/or retrieve coupons saved in their online accounts at any desired time. Notwithstanding the manner in which a given coupon is displayed to a user 18, the user 18 may select the coupon by clicking the “print” button B1 so that the coupon 38 is displayed on the screen of the mobile phone, as shown in FIG. 4C. In turn, the user 18 may redeem the coupon 38 by presenting the mobile phone to a vendor (e.g., the vendor may scan the barcode 42 or enter the barcode number 43).

Alternatively, a user 18 may use his or her mobile phone to download an application operable to synchronize data between the user's online account (e.g., a Yahoo! Deals account) and the mobile phone. The application may be similar to those developed for iPhones and BlackBerry phones, such as certain applications developed for Facebook, Inc. that enable users to access their Facebook accounts through their mobile phones.

For instance, FIG. 4A depicts an iPhone 44 including an icon corresponding to an exemplary Yahoo! Deals application 46. Opening the application 46 (e.g., by touching the Yahoo! Deals icon) causes a Yahoo! Deals interface 47 to display, as shown in FIG. 4B. The interface 47 includes an “Ad Basket” that lists all coupons saved by the user 18 in his or her Yahoo! Deals account. In other words, the “Ad Basket” includes coupons that the user 18 has saved using any client device, not merely the iPhone 44. If a user selects a coupon 38, the coupon 38 is displayed on the screen of the iPhone 44 so that it may be redeemed (e.g., by scanning the barcode 42).

Of course, it should be understood to those of skill in the art that the Yahoo! Deals application 46 described above may include a wide range of additional functions. For instance, the application 46 may include functionality for integrating the coupon 38 with other applications installed on the mobile phone 44. In one aspect, the application 46 is operable to supply the expiration date 40 to a calendar application 48, which the user 18 may configure to generate one or more reminders as the coupon 38 nears its expiration date 40.

Moreover, the application 46 may allow users 18 to delete one or more coupons from the “Ad Basket” 48. Since the application 46 is synchronized with the users Yahoo! Deals account, any deleted coupons would therefore be deleted from the Yahoo! Deals account. Similarly, if a user 18 deletes a coupon from his or her Yahoo! Deals accounts by accessing the network 14 via a separate client device (e.g., personal computer), the coupon will be deleted from the “Ad Basket” 48. The “Ad Basket” 48 may be updated at predetermined time intervals, automatically, or manually (e.g., the application 46 may include a “refresh” button). In addition, if a saved coupon is redeemed or expired, the coupon may be automatically rendered invalid and/or deleted from the user's Yahoo! Deals account.

According to another aspect, the application 46 may include a search function for allowing users 18 to search for online coupons offered by businesses within close proximity. For instance, the application 46 may determine a user's current location based on a global positioning system (GPS) or a map/compass application 50 incorporated with the user's mobile phone 44. In response to a search request, therefore, the application 46 may return a list of hyperlinks pertaining to businesses closest to the user 18. If a user 18 clicks on a hyperlink, the user 18 may be redirected to a list of online deals associated with the business.

The search function may sort online deals based on a summed evaluation of radial distance from the user, online reviews of the business or the products/services offered by the business, prices associated with the advertised products/service, etc. By way of example, search results may be ordered based on a weighted average aggregated from information obtained from a mapping website (e.g., www.maps.yahoo.com), a local website (e.g., www.local.yahoo.com), and the Yahoo! Deals website. In one aspect, the search function utilizes an aggregation equation such as the following:

Σwᵢqᵢ,

where:

i is an integer;

q is a quantity indicative of radial distance, online ratings, total number of deals, prices, etc.; and

w is a weight in inverse q units.

As will be understood by those of skill in the art, Yahoo! Deals and/or advertisers 16 may track certain conversions associated with the online advertisements 24 in order to generate data and performance reports. Such conversions may include whether a coupon has been redeemed, saved, printed, deleted, sent, shared, and/or commented on. As will be understood by those of skill in the art, Yahoo! Deals and advertisers 16 may utilize the foregoing information to improve ad targeting.

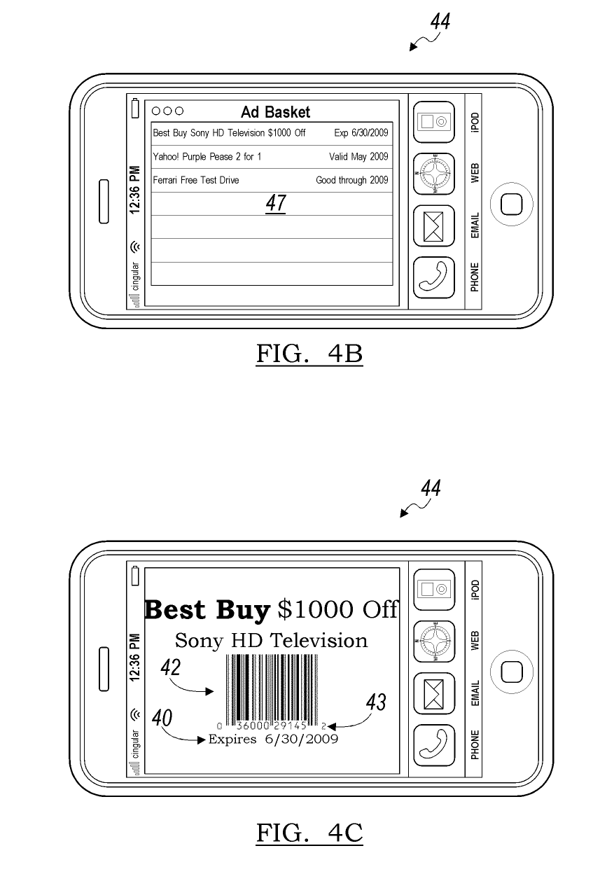

Referring now to FIG. 5, a method 200 for automatically customizing advertisements in online and mobile applications starts in block 202. At block 204, a plurality of electronic coupon files are received. The electronic coupon files including information for generating redeemable coupons. At block 206, the electronic coupon files are stored in a storage medium such as the coupon database 20 described above. Advertisements 24 associated with the electronic coupon files are generated at block 208. At block 210, the advertisements 24 are stored in a storage medium such as the advertisement database 26 described above.

Continuing with block 212, an advertisement 24 is rendered to an online user 18. It is to be understood that the advertisement 24 may be selected according to any of the techniques described above. At block 214, the user 18 is redirected to a predetermined URL in response to clicking an area of the advertisement 24. A printable copy of a redeemable coupon 38 associated with the advertisement 24 is displayed to a user 18 at block 216. The coupon 38 may be displayed in response to a user 18 clicking an interactive component embedded within the coupon 38. The method ends at block 218.

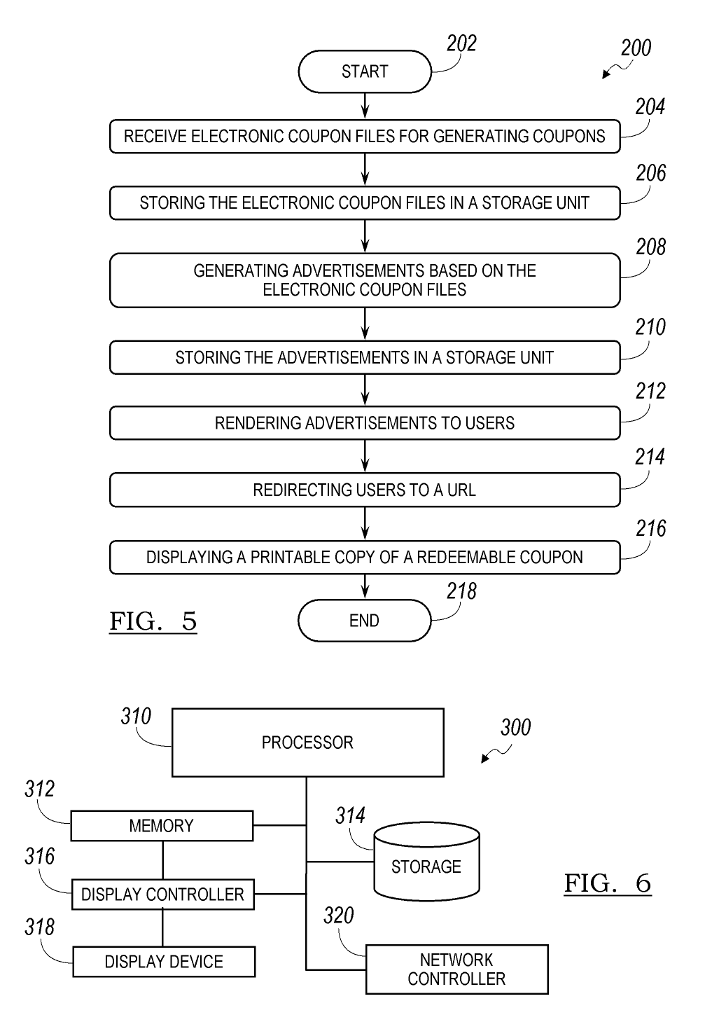

Any of the modules, servers, or engines described may be implemented in one or more computer systems. One exemplary system is provided in FIG. 6. The computer system 300 includes a processor 310 for executing instructions such as those described in the methods discussed above. The instructions may be stored in a computer readable medium such as memory 312 or storage devices 314, for example a disk drive, CD, or DVD. The computer may include a display controller 316 responsive to instructions to generate a textual or graphical display on a display device 318, for example a computer monitor. In addition, the processor 310 may communicate with a network controller 320 to communicate data or instructions to other systems, for example other general computer systems. The network controller 320 may communicate over Ethernet or other known protocols to distribute processing or provide remote access to information over a variety of network topologies, including local area networks, wide area networks, the Internet, or other commonly used network topologies.

In another embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this application. This description is not intended to limit the scope or application of this application in that the system 10 is susceptible to modification, variation and change, without departing from spirit of this application, as defined in the following claims. Furthermore, it should also be understood that the present application is not limited to a particular website or collection of websites, although many of the examples show examples associated with the Yahoo! website.

We claim:

1. A system for generating interactive advertisements, the system comprising:
a coupon database for storing a plurality of electronic coupon files, each electronic coupon file of the plurality of electronic coupon files including data for generating a redeemable coupon, the data including a unique identifier associated with the redeemable coupon;
an advertisement generator communicatively linked to the coupon database and operable to generate at least one advertisement associated with an electronic coupon file selected from the plurality of electronic coupon files, the at least one advertisement including an ad body and a set of interactive components;
an advertisement database communicatively linked to the advertisement generator and configured to store the at least one advertisement; and
an ad server communicatively linked to the advertisement database and operable to render the at least one advertisement to a user, the set of interactive components being visibly embedded within the at least one advertisement;
wherein the user is redirected to a predetermined URL in response to clicking an area of the ad body, the area of the ad body not including the set of interactive components; and
wherein the set of interactive components includes a first button operable to display a printable copy of the redeemable coupon in response to the user clicking on the first button, the unique identifier being visibly embedded within the printable copy of the redeemable coupon.

2. The system of claim 1, wherein the set of interactive components includes a second button for enabling the user to save the redeemable coupon in a storage medium.

3. The system of claim 2, wherein the storage medium includes an online account associated with the user.

4. The system of claim 3, wherein the unique identifier includes a barcode to be scanned for redeeming the redeemable coupon, the redeemable coupon becoming invalid upon redemption.

5. The system of claim 4, wherein the online account is accessible to the user by way of a client device communicatively linked to a network, the client device including at least one mobile phone operable to download an application that synchronizes information between the online account and the application.

6. The system of claim 5, wherein running the application displays an interactive interface that enables the user to view the redeemable coupon on the mobile phone.

7. The system of claim 6, wherein the application includes a search function for allowing the user to search for a plurality of redeemable coupons offered by at least one business proximal to the user, the location of the user being determined from a global positioning system (GPS) incorporated within the mobile phone.

8. The system of claim 1, further comprising at least one back-end server operable to obtain information associated with the user, the at least one back-end server being communicatively linked to the ad server and operable to communicate the information thereto, wherein the ad server selects the at least one advertisement based on the information associated with the user.

9. The system of claim 2, wherein the set of interactive components includes a third button for enabling the user to perform at least one action selected from the group consisting of: sending the redeemable coupon, sharing the redeemable coupon on an online website, and posting a comment to be viewed by online users.

10. A method for generating an interactive advertisement, the method comprising:
receiving a plurality of electronic coupon files, each electronic coupon file of the plurality of electronic coupon files including data for generating a redeemable coupon, the data including a unique identifier associated with the redeemable coupon;
storing the plurality of electronic coupon files in a coupon database;
generating at least one advertisement associated with an electronic coupon file selected from the plurality of electronic coupon files, the at least one advertisement including an ad body and a set of interactive buttons;
storing the at least one advertisement in an advertisement database;
rendering the at least one advertisement to a user, the set of interactive buttons being visibly embedded within the at least one advertisement;
redirecting the user to a predetermined URL in response to the user clicking an area of the ad body, the area of the ad body not including the set of interactive buttons; and
displaying a printable copy of the redeemable coupon to the user in response to the user clicking a first button selected from the set of interactive buttons, wherein the unique identifier is visibly embedded within the printable copy of the redeemable coupon.

11. The method of claim 10, further comprising storing the redeemable coupon in an online account in response to the user clicking a second button selected from the set of interactive buttons.

12. The method of claim 10, wherein the unique identifier includes a barcode to be scanned for redeeming the redeemable coupon, the redeemable coupon becoming invalid upon redemption.

13. The method of claim 12, further comprising synchronizing information between the online account and an application installed on a client device associated with the user, the client device including at least one mobile phone.

14. The method of claim 13, wherein running the application displays an interactive interface for enabling the user to view the redeemable coupon on the mobile phone.

15. The method of claim 10, further comprising applying an algorithm to select the at least one advertisement, the algorithm being based on information obtained regarding the user.

16. In a computer readable storage medium having stored therein instructions executable by a programmed processor for generating interactive advertisements, the storage medium comprising instructions for:
receiving a plurality of electronic coupon files, each electronic coupon file of the plurality of electronic coupon files including data for generating a redeemable coupon, the data including a unique identifier associated with the redeemable coupon;
storing the plurality of electronic coupon files in a coupon database;
generating at least one advertisement associated with an electronic coupon file selected from the plurality of electronic coupon files, the at least one advertisement including an ad body and a set of interactive buttons;
storing the at least one advertisement in an advertisement database;
rendering the at least one advertisement to a user, the set of interactive buttons being visibly embedded within the at least one advertisement;
redirecting the user to a predetermined URL in response to the user clicking an area of the ad body, the area of the ad body not including the set of interactive buttons; and
displaying a printable copy of the redeemable coupon to the user in response to the user clicking a first button selected from the set of interactive buttons, wherein the unique identifier is visibly embedded within the printable copy of the redeemable coupon.

17. The computer readable storage medium of claim 16, further comprising storing the redeemable coupon in an online account in response to the user clicking a second button selected from the set of interactive buttons.

18. The computer readable storage medium of claim 17, wherein the unique identifier includes a barcode to be scanned for redeeming the redeemable coupon, the redeemable becoming invalid upon redemption.

19. The computer readable storage medium of claim 18, further comprising instructions for synchronizing information between the online account and an application installed on a client device associated with the user, the client device including at least one mobile phone.

20. The computer readable storage medium of claim 19, wherein running the application displays an interactive interface for enabling the user to view the redeemable coupon on the mobile phone.

21. The computer readable storage medium of claim 16, further comprising instructions for applying an algorithm to select the at least one advertisement, the algorithm being based on information obtained regarding the user.
